(19) United States
(12) Patent Application Publication
(10) Pub. No.: US 2011/0179906 A1
(43) Pub. Date: Jul. 28, 2011

(54) DRIVE ASSEMBLY FOR A MOTOR VEHICLE DRIVEN BY A PLURALITY OF AXLES

(76) Inventors: Peter Juenemann, Lohmar (DE); Fred Kramer, Wachtberg (DE); Michael Schwekutsch, Wermelskirchen (DE); Mark Schmidt, Koenigswinter (DE); Theodor Gassmann, Siegburg (DE)

(21) Appl. No.: 13/059,138

(22) PCT Filed: Jul. 22, 2009
(86) PCT No.: PCT/EP09/05313

§ 371 Date: Mar. 24, 2011

(30) Foreign Application Priority Data
Aug. 15, 2008 (DE) 10 2008 037 886.0

(51) Int. Cl. F16H 37/06; F16H 48/24

(52) U.S. Cl. 74/665 F; 475/220

(57) ABSTRACT

The invention relates to a drive assembly for a motor vehicle with a drive unit and multiple driven axles. The drive assembly comprises a transfer case 12 which distributes torque introduced by the drive unit 4 to a first driveline 5 and to a second driveline 7, wherein the first driveline 5 is permanently drivingly connected to the transfer case 12 in order to transfer torque to a first driving axle 6 and wherein optionally, in addition to the first driveline 5, the second driveline 7 can be drivingly connected to the transfer case 12 in order to transfer torque to the second driving axle 8, and a propeller shaft 24 which is arranged in the torque flow between the transfer case 12 and the second driving axle 8, wherein there are provided first coupling means 22 for coupling and uncoupling the propeller shaft 24 relative to the drive unit 4, as well as second coupling means 26 for coupling and uncoupling the propeller shaft 24 relative to the second driving axle 8.

The invention relates to a drive assembly for a motor vehicle driven by a plurality of axles. The drive assembly comprises a first driveline for permanently driving a first driving axle as well as a second driveline which, if required, can be connected in order to transmit torque to the second driveline. Such drive assemblies with an optionally connectable driving axle are also referred to as “hang-on” or “on-demand” systems.

Generally, one differentiates between different drive concepts for motor vehicles. There are vehicles with a front engine in which the front axle is driven permanently, with the rear axle being connectable on demand. Furthermore, there are vehicles with a front engine in the case of which, on the other hand, the rear axle is permanently driven, with the front axle being connectable on demand. Finally, there are also known vehicles with a rear engine in which the rear axle is permanently driven, with the front axle, if required, being connected by a hang-on coupling.

From EP 0 466 863 B1 there is known a device for connecting a driveline in a motor vehicle with a transfer case for a plurality of drivelines. One of the drivelines is permanently connected to a drive unit and a further driveline is connectable on demand to the drive unit. For connecting the driveline, there is provided an electronically controllable friction coupling which can be arranged in a transfer case or in a differential drive.

With such drive assemblies with an on-demand driveable driveline, the associated driving axle is not permanently driven in order to keep losses as low as possible. But in the disconnected condition, too, the torque transmitting components of the on-demand connectable driving axis also rotate, which leads to unwanted power losses. It is due to these power losses that motor vehicles driven by a plurality of axles with a hang-on driveline feature a higher fuel consumption than vehicles driven by one axle.

It is therefore the object of the present invention to propose a drive assembly for a motor vehicle driven by a plurality of axles, which generates low drag moments and low power losses, thus achieving a reduction in fuel consumption.

The objective is achieved by providing a drive assembly for a motor vehicle with a drive unit and multiple driven axles, the drive assembly comprising a transfer case which distributes torque introduced by the drive unit to a first driveline and to a second driveline, wherein the first driveline is permanently drivingly connected to the transfer case in order to transmit torque to a first driving axle, and wherein optionally, in addition to the first driveline, the second driveline can be drivingly connected to the transfer case in order to transmit torque to the second driving axle, and a propeller shaft which is arranged in the torque flow between the transfer case and the second driving axle, wherein there are provided first coupling means for coupling and uncoupling the propeller shaft relative to the drive unit, as well as second coupling means for coupling and uncoupling the propeller shaft relative to the second driving axle.

The advantage of the inventive drive assembly consists in that the propeller shaft with all its rotating parts, more particularly also the bearing means for rotatably supporting the propeller shaft, can be disconnected from the drive unit, the special characteristic being that, in the disconnected condition, the propeller shaft is stopped from rotating so that undesirable drag moments cannot occur. By having the drivingly rotatable components stand still it is achieved that the associated bearings in which the components are rotatably supported also stand still. As a result, the friction forces occurring in the disconnected condition of the connectable second driving axle are minimised. The bearings are preferably provided in the form of tapered roller bearings. A further aspect of the inventive drive assembly is that the assemblies which are drivingly connected to the propeller shaft at the input end and at the output end, for example angle drives, can also be uncoupled, which again leads to a reduction in power losses due to a reduction in drag moments and friction forces.

The inventive drive assembly is particularly suitable for motor vehicles with a permanently driven front axle, which would then be the first driving axle, and with an optionally driveable rear axle which would then constitute the second driving axle. However, it is also conceivable that the rear axle of the motor vehicle is permanently driven (first driving axle) and that the front axle is optionally driveable (second driving axle).

According to a preferred embodiment, the connectable second driveline comprises a first angle drive which is arranged in the torque flow between the drive unit and the propeller shaft. The angle drive serves to transmit the torque from a shaft connected to the drive unit to the propeller shaft. In principle, the first coupling means can be arranged in any place within the torque flow between the drive unit and the propeller shaft. To achieve particularly low power losses it is advantageous if the first coupling means are arranged in the torque flow upstream the angle drive. When opening the coupling means, said measure ensures that also the angle drive disposed upstream in the torque flow of the propeller shaft can be uncoupled from the drive, so that both assemblies are standing still. Depending on the installation space conditions in the region of the front axle, the input shaft of the angle drive can be arranged coaxially relative to the first driving axle, but also parallel relative thereto. The same applies to the first coupling means which can be arranged coaxially relative to or parallel to the first driving axle.

The transfer case is preferably provided in the form of a differential drive which comprises an input part and three output parts. The input part is at least indirectly connected to the drive unit and is permanently driven by same. The first and the second output parts, which are drivingly connected to the input part, serve to distribute the torque to the first and the second sideshaft of the associated first driving axle. The third output part which is also drivingly connected to the input part is optionally connectable to the second driveline, wherein, in a connected condition, part of the torque introduced into the differential drive is transmitted to the second driving axle.

The first differential drive preferably comprises a differential carrier in the form of the input part which can be driven by the drive unit. In the differential carrier there are received differential gears which rotate around the axis of rotation together with the differential carrier, as well as sideshaft gears which are rotatably supported on the axis of rotation A and engage the teeth of the differential gears. According to a preferred embodiment, the differential carrier also serves as the third output part of the axle differential. For this purpose, a free end of the differential carrier is drivingly connected to the input part of the first coupling means. Both components, i.e. the differential carrier and the input part of the coupling means are jointly driven by the drive unit. The output part of the first coupling means is connected to an input shaft of the angle drive in a rotationally fixed way, so that, when the coupling means are closed, torque is transmitted to the angle drive and from there to the propeller shaft.

According to a preferred embodiment, the optionally driveable second driveline comprises a second angle drive for transmitting torque from the propeller shaft to the second driving axle. The second angle drive comprises a bevel gear connected to the propeller shaft in a rotationally fixed way and a ring gear which engages same, which is coaxially arranged relative to the second driving axle and introduces torque into the second driving axle. The second driving axle comprises a second differential drive which serves to distribute torque to the two sideshafts. The second coupling means are preferably arranged in the torque flow between the second angle drive and the second differential drive. This is advantageous in that, when the second coupling means are disconnected, the second angle drive is also standing still, as a result of which power losses are kept particularly low. More particularly, it is proposed that the second coupling means comprise an input part and an output part, with the input part being connected in a rotationally fixed way to the ring gear of the second angle drive and with the output part being connected in a rotationally fixed way to the differential carrier of the second differential drive.

The design of the coupling means is generally optional and depends on the installation space conditions and requirements of the coupling means. Both coupling means are externally controlled, with the control signal for opening and closing being generated as a function of the driving conditions of the motor vehicle by an electronic control unit. Coupling means are particularly suitable in the form of form-fitting couplings which, below, will be referred to as clutches, or force-locking couplings, for example friction couplings. More particularly, the following embodiments are conceivable:

The first coupling means are provided in the form of a clutch and the second coupling means in the form of a friction coupling. This embodiment is particularly suitable for applications wherein the installation space available in the region of the first driving axle is small. A reversed arrangement is also conceivable wherein the first coupling means are provided in the form of a friction coupling and the second coupling means in the form of a clutch. According to a further embodiment it is proposed that both coupling means are provided in the form of friction couplings, in which case the speeds between the input parts and output parts can be set accurately, which permits a “soft” switching on and switching off process, with undesirable switching noises being avoided. As an alternative it is conceivable for the first and the second coupling means to be provided in the form of clutches. In this embodiment it is advantageous for an accurate control of the torque transferable to the second driving axle if, inside said second driveline, there is provided a further coupling in he form of an externally actuatable friction coupling.

According to a further embodiment, the second coupling means can comprise a friction coupling and a form-fitting coupling. This is advantageous in that the output part of the friction coupling can be disconnected, so that the drag moments in the friction coupling are again reduced when the form-fitting coupling is in the open condition.

According to yet another embodiment, the first coupling means can comprise a form-fitting coupling and a synchronising unit. The synchronising unit is advantageous in that, prior to being connected, the speeds of the coupling input part and of the coupling output part of the form-fitting coupling are adjusted to one another. This, in turn, leads to a reduction in switching noise.

According to a further embodiment wherein the permanently driven first driving axle constitutes the rear axle and the optionally driveable second driving axle the front axle of the motor vehicle, the transfer case comprises a direct drive which permanently drives the rear first driving axle via a first propeller shaft. Furthermore, the transfer case comprises first coupling means for on-demand connecting the second driveline, wherein the second driveline comprises a second propeller shaft for driving the front second driving axle. The second coupling means preferably comprise a friction coupling. However, it is also possible—more particularly under restricted installation conditions—to use a form-fitting coupling.

According to a preferred embodiment, the propeller shaft is provided in several parts, i.e. it comprises a first shaft portion and a second shaft portion. The two shaft portions can be connected to one another by a constant velocity universal joint which permits angular movements between the two shaft portions. Furthermore, in the connecting regions, there can be provided an intermediate bearing by means of which the propeller shaft can be fixed relative to the vehicle body. If there are provided third coupling means, these are preferably arranged between the first and the second shaft portion.

Preferred embodiments will be described below with reference to the drawings wherein

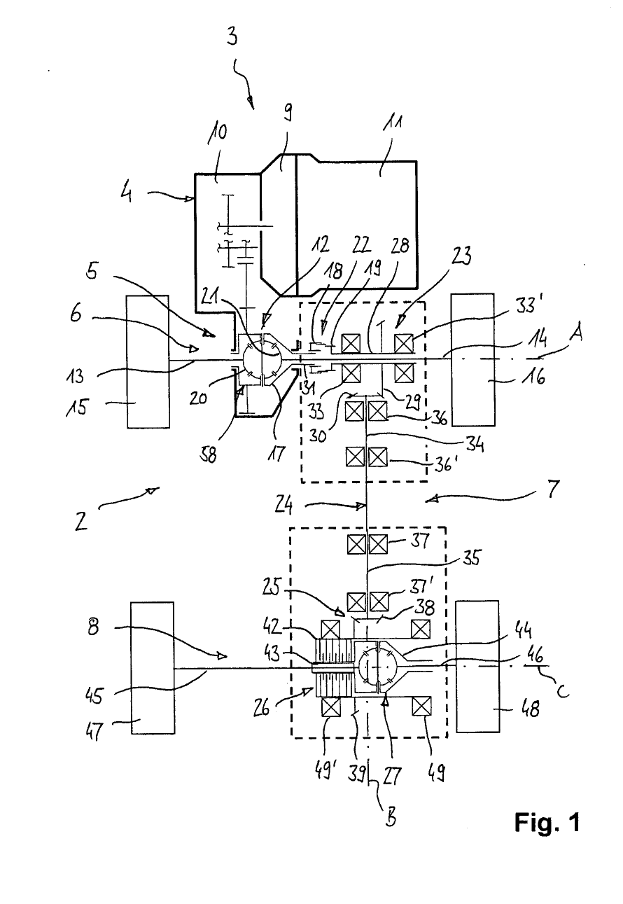

FIG. 1 schematically shows an inventive drive assembly with a connectable driving axle in a first embodiment.

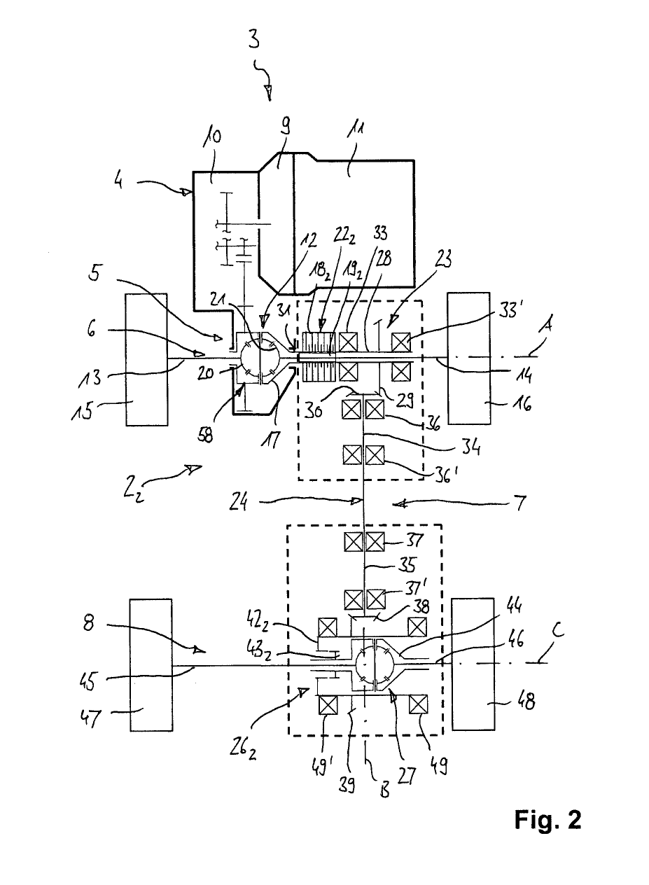

FIG. 2 schematically shows an inventive drive assembly with a connectable driving axle in a second embodiment.

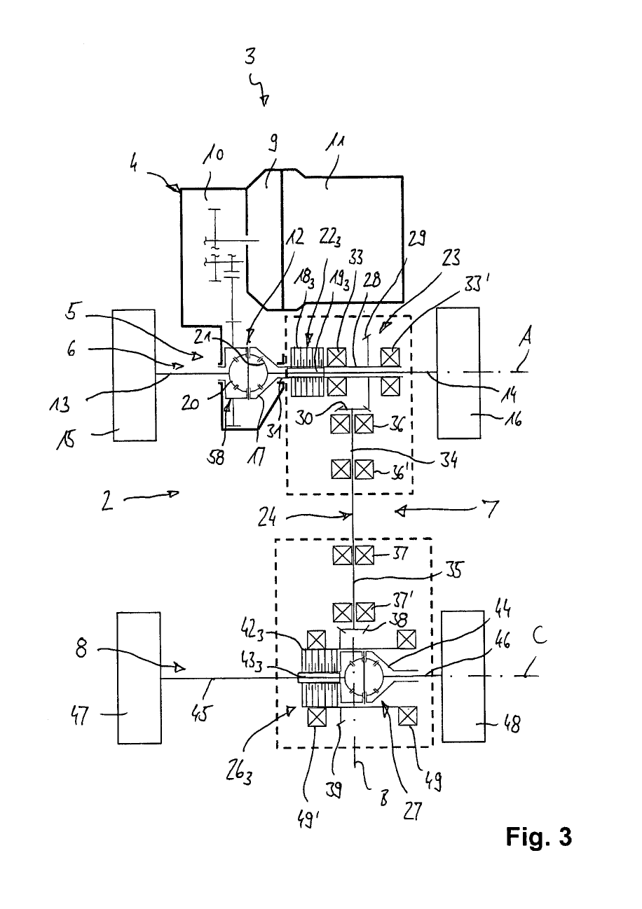

FIG. 3 schematically shows an inventive drive assembly with a connectable driving axle in a third embodiment.

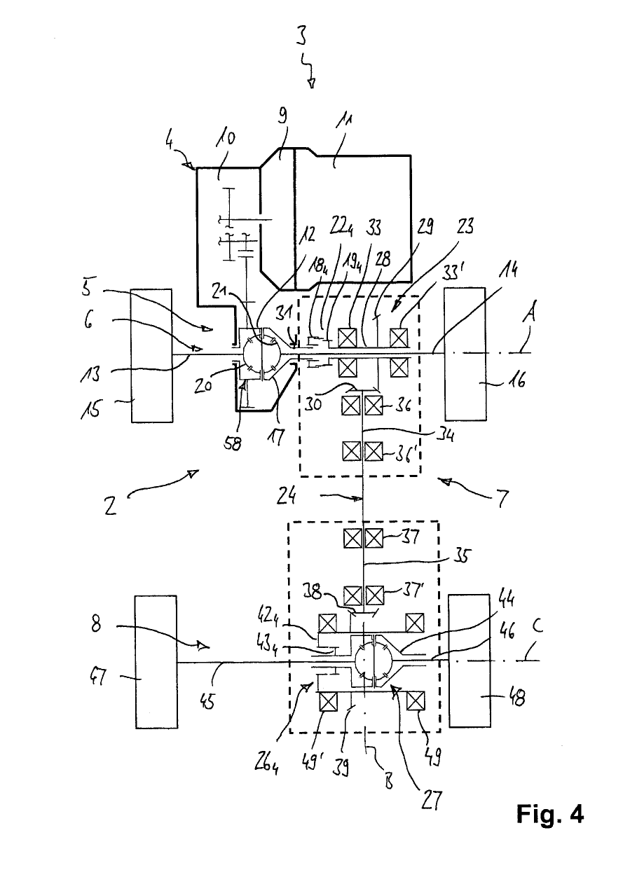

FIG. 4 schematically shows of an inventive drive assembly with a connectable driving axle in a fourth embodiment.

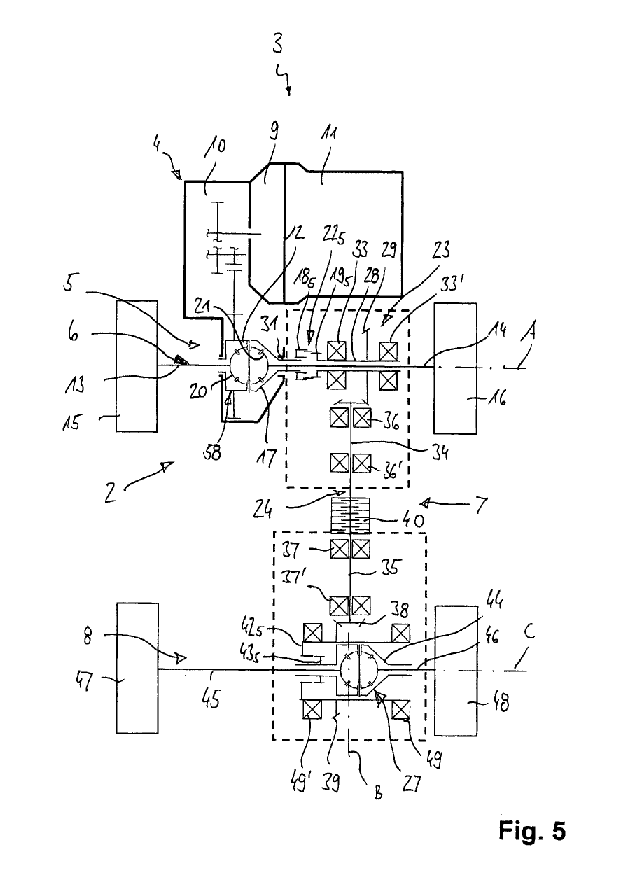

FIG. 5 schematically shows an inventive drive assembly with a connectable driving axle in a fifth embodiment.

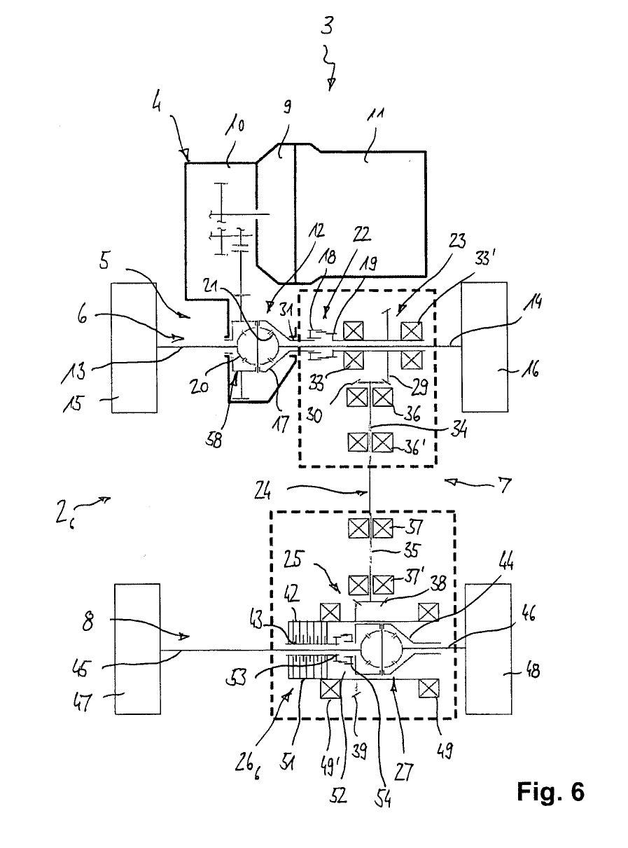

FIG. 6 schematically shows an inventive drive assembly with a connectable driving axle in a sixth embodiment.

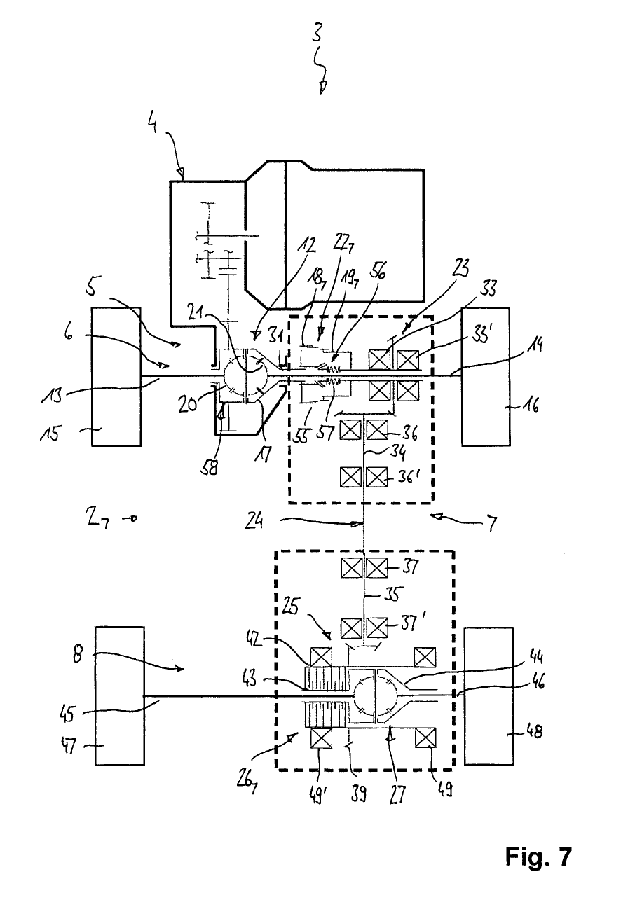

FIG. 7 schematically shows an inventive drive assembly with a connectable driving axle in a seventh embodiment.

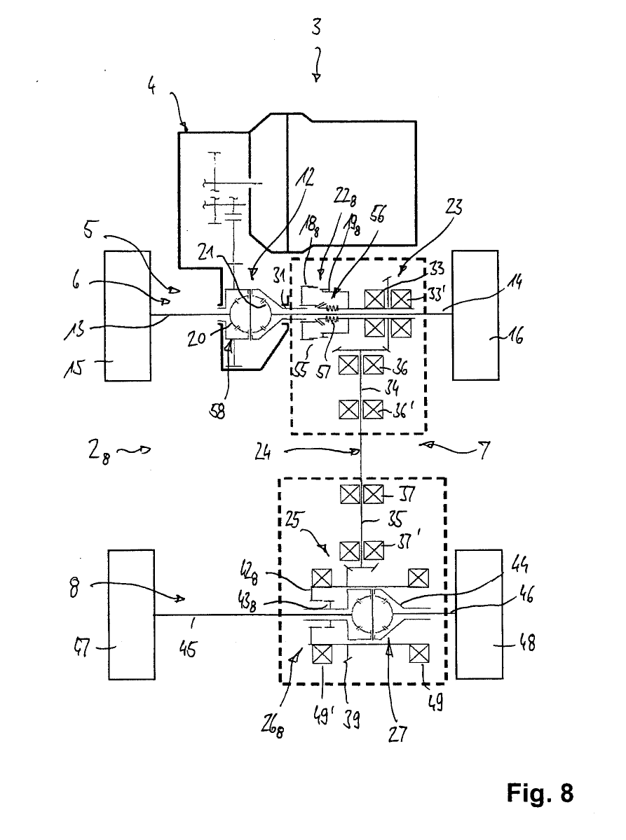

FIG. 8 schematically shows an inventive drive assembly with a connectable driving axle in an eighth embodiment.

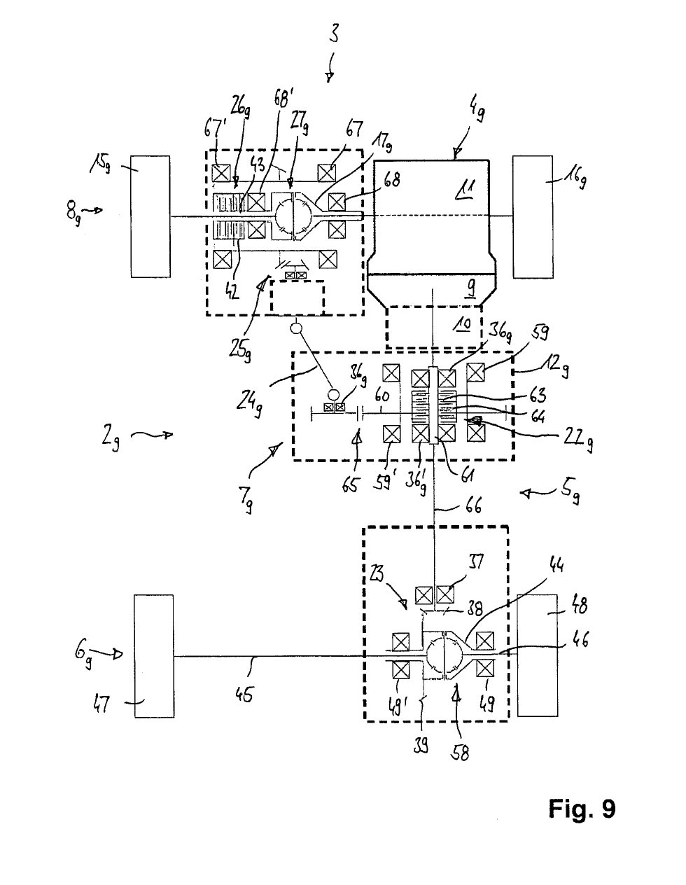

FIG. 9 schematically shows an inventive drive assembly with a connectable driving axle in a ninth embodiment.

Initially, FIGS. 1 to 5 will be described jointly in respect of the features which they have in common. There is diagrammatically shown a drive assembly 2 for a motor vehicle 3 driven by a plurality of axles. Of the motor vehicle 3 it is possible to see the drive unit 4, a first driveline 5 for driving a first driving axle 6 and a second driveline 7 for driving a second driving axle 8. The drive unit 4 comprises an internal combustion engine 11, a coupling 9 and a gearbox 10 via which torque is introduced into the first and the second driveline 5, 7. It goes without saying that the drive unit can also be any other drive, for an example an electric motor.

For distributing the torque generated by the drive unit 4 to the first driveline 5 and to the second driveline 7, there is provided a transfer case 12. The transfer case 12 preferably comprises a differential drive 58 which comprises an input part 17 and three output parts 20, 21, 23 which have an equalising effect relative to one another. The input part 17 of the differential drive 58 is provided in the form of a differential carrier which is driven by the drive unit 4. For this purpose, there is provided a ring gear which is connected to the differential carrier in a rotationally fixed way and whose teeth engage a gear of the gearbox 10.

In principle, the first driveline 5 is formed by the differential carrier which, via differential gears rotatably supported in the differential carrier and jointly rotating therewith around the axis of rotation A, transmits torque to the first and the second output part 20, 21. The first and the second output part 20, 21 of the differential drive 58 are provided in the form of sideshaft gears which engage the differential gears. The sideshaft gears are each connected in a rotationally fixed way to an associated sideshaft 13, 14 via which the introduced torque is transmitted to the associated wheels 15, 16.

The third output part 31 is drivingly connected to the second driveline 7, wherein the second driveline 7, if required, can be optionally connected to the first driveline 5 for transmitting torque to the second driving axle 8. The third output part 31 is formed by a free end of the differential carrier, which free end is connected in a rotationally fixed way to an input part of the second driveline 7.

The second driveline 7 comprises, in series, the following assemblies which are drivingly connected with each other for torque transmitting purposes: first coupling means 22, a first angle drive 23, a propeller shaft 24, a second angle drive 25, second coupling means 26 as well as a second axle differential 27 which serves to drive the second axle 8. It goes without saying that the above series of assemblies is not necessarily obligatory. For example, the first coupling means, in principle, can also be arranged behind the first angle drive.

The first coupling means 22 comprise an input part 18 which is indirectly connected to the drive unit 4, more particularly via the differential carrier 17. Furthermore, the coupling means 22 comprise an output part 19 which can be connected to or separated from the input part 18. The output part 19 is connected to the input shaft 28 of the angle drive 23 in order to introduce torque into the angle drive 23 for driving the second driving axle 8. It can be seen that the input shaft 28 of the angle drive 23 is arranged coaxially relative to the axis of rotation A around which the differential carrier 17 rotates. The input shaft 28 is provided in the form of a hollow shaft and is rotatably arranged on the sideshaft 14. The input shaft 28, in turn, is connected, in a rotationally fixed way to the ring gear 29 which engages a bevel gear in order to rotatingly drive the propeller shaft 24. By means of first and second bearing means 33, 33′, the input shaft 28 of the first angle drive 23 is supported so as to be rotatable around the axis of rotation A. The bearing means 33, 33′ are preferably provided in the form of rolling-contact bearings, with other types of bearing not being excluded. It goes without saying that the angle drive 23, which is also referred to as “power take-off unit” or as “power transfer unit” (PTU), could also be arranged on an axis of rotation arranged parallel to the first driving axis 6.

The propeller shaft 24, which is shown diagrammatically, is preferably provided in the form of a multi-component shaft which comprises a first shaft portion 34 and a second shaft portion 35 connected thereto in a rotationally fixed way. Depending on the length of the propeller shaft 24, it is possible to provide an intermediate joint and an intermediate bearing (not shown). It can be seen that the front shaft portion 34 is rotatably supported by two bearing means 36, 36′ and that the rear shaft portion 35 is rotatably supported by further bearing means 37, 37′ around an axis of rotation B.

The second angle drive 25 comprises a driving pinion 38 as well as a ring gear 39 which engages the pinion 38 and constitutes the output. The ring gear 39 is connected to an input part 42 of the coupling means 26 in a rotationally fixed way. The output part 43 of the second coupling means 25 is connected to the differential carrier 44 of the rear axle differential 27 in a rotationally fixed way to allow the transmission of torque to same. In addition to the differential carrier 44, the rear axle differential comprises differential gears which are not described in greater detail and which rotate jointly with the differential carrier 44 around the axis of rotation C, as well as two sideshaft gears which engage the differential gears and which are connected in a rotationally fixed way to the sideshafts 45,46 of the motor vehicle 3. At the ends of the sideshafts 45, 46 there are provided the rear wheels 47, 48. It can be seen that the coupling part 42 is supported by bearing means 49, 49′ so as to be rotatable around the axis of rotation C. In this case, too, the bearing means 49, 49′ are preferably provided in the form of rolling contact bearings, but other bearing means such as friction bearings can also be used.

The special feature of the present invention is that, by means of the first coupling means 22 and the second coupling means 26, the front angle drive 23, the propeller shaft 24 and the rear angle drive 25 can be disconnected when the first and the second coupling means 22, 26 are open. In such a deactivated condition, said assemblies as well as the associated components are standing still, so that power losses due to drag moments and friction are reduced. This, in turn, results in a reduced fuel consumption for those vehicle conditions in which only the first driving axle 6 is driven, with the second driving axle 8 running in a torque-free condition.

Below, there will follow a description of the special features of the individual embodiments.

In the embodiment according to FIG. 1, the first coupling means 22 are provided in the form of a clutch. In this regard, clutch means that the input part and the output part of the clutch can be separated from each other. For torque transmitting purposes, the input part and the output part of the switching clutch are connected to one another by form-fitting means. Examples for form-fitting clutches are dog clutches, claw couplings or toothed couplings.

In the present embodiment, the second coupling means 26 are provided in the form a a force-locking friction coupling. The friction coupling comprises an outer plate carrier constituting the input part 42 to which the outer plates are connected in a rotationally fixed and axially displaceable way, as well as an inner plate carrier constituting the output part 43 to which inner plates are connected in a rotationally fixed and axially displaceable way. By axially loading the plate package consisting of the outer plates and inner plates by an axial setting device (not illustrated), the friction coupling is closed and the speed between the input part 42 and the output part 43 is equalised.

For driving conditions in which only the first driving axle 6 is driven, the first coupling means 22 and the second coupling means 26 are opened so that all drive parts positioned in the torque flow between the two couplings 22, 26 are stationary. In such a driving condition, power losses due to drag moments and friction are minimised. In the case of driving conditions in which both driving axles 6, 8 are to be driven, first the friction coupling 26 is actuated in such a way that the speed of the output part 19 of the clutch 22 is equalised relative to the input part 18 of the clutch. Then the clutch 22 can be closed without generating any switching noise, so that the second driveline 7 is connected. Thus, part of the torque introduced into the transfer case 12 is transmitted via the propeller shaft 24 to the coupling input part 42 of the second coupling means 26. In this condition, it is now possible, by actuating the axial setting device in accordance with requirements, to transmit torque to the rear axle 6. The present embodiment with a dog clutch arranged in the front and with a friction coupling arranged in the rear is advantageous in that in the region of the front axle only a small installation space is required, which has positive effects on packaging.

The embodiment shown in FIG. 2 largely corresponds to that shown in FIG. 1, so that, as far as common features are concerned, reference can be made to the above description. Identical components have been given the same reference numbers, and any reference numbers of components which are modified relative to FIG. 1 have been given the subscript 2.The only difference is that the coupling means 22₂ associated with the first axle 6 are provided in the form of a friction coupling, whereas the coupling means 26₂ associated with the second axle 8 are provided in the form of a clutch. This design is particularly suitable in those cases where the installation conditions in the first driving axle 6 permit the larger friction coupling to be integrated. The mode of functioning corresponds to that shown in FIG. 1, i.e. if only the first axle 6 needs to be driven, both coupling means 22₂, 26₂ are opened. If, however, the second driving axle 8 is to be driven as well, both coupling means 22₂, 26₂ have to be closed. For this purpose, the initially friction coupling 22₂ is actuated in such a way that the speed equalisation between the output part 42₂ and the input part 43₂ of the clutch 26₂ takes place at least partially. Then the clutch 26₂ can be closed with a low switching noise, as a result of which the second driveline 7₂ is connected. By controlling the axial setting device (not shown) which acts on the plate package of the friction coupling 22₂, it is possible to transmit torque to the second driving axle 8₂ depending on requirements.

The embodiment shown in FIG. 3 largely corresponds to that shown in FIGS. 1 and 2, so that, as far as common features are concerned, reference can be made to the above description. Identical components have been given the same reference numbers, and the reference numbers of any components which are modified have been given the subscript 3. It can be seen that in the present embodiment, the first and the second coupling means 22₃, 26₃ have been provided in the form of friction couplings. In the case of the front friction coupling, one of the coupling parts 18, 19, which are rotatable relative to one another, is connected to the differential carrier 17, whereas the other one of the two coupling parts 19, 18 is connected in a rotationally fixed way to the input shaft 28 of the first angle drive 23. The present drive assembly 2 is advantageous in that as a result of the two friction couplings, there exist flexible connection dynamics. Furthermore, as far as their mode of functioning is concerned, the two couplings 22₃, 26₃ can be provided separately. The front first friction coupling can be designed only for coupling the connectable driveline 7, whereas the rear second friction coupling can be designed for on demand controlling the torque to be transmitted to the second driving axle 8. The present drive assembly 2 with two friction couplings allows the connection of the second driveline even at high speed differentials between the front axle and the rear axle. In addition, connecting the second driving axle 8 does not generate any undesirable switching noise.

The embodiment shown in FIG. 4 largely corresponds to that shown in FIGS. 1 and 2, so that, as far as common features are concerned, reference can be made to the above description. Identical components have been given the same reference numbers, and the reference numbers of any components which are modified have been given the subscript 4. The special feature of the embodiment according to FIG. 4 is that the first and the second coupling means 22₄, 26₄ have both been provided in the form of clutches. As in the case of the above embodiments, these are closed if the second driving axle 8 shall be driven on demand, and they are opened if only the first driving axle 6 is to be driven. More particularly, the dog clutches can be provided in the form of claw coupling or toothed couplings. As a speed equalisation between the respective input part and output part of the form-fitting clutches is not possible, in the case of the present driveline 2, connection can only take place if the vehicle 3 is driving very slowly or is in a stationary condition.

The embodiment shown in FIG. 5 largely corresponds to that shown in FIG. 4, so that, as far as common features are concerned, reference can be made to the above description. Identical components have been given the same reference numbers, and the reference numbers of any components which are modified have been given the subscript 5. The only difference between the present embodiment and that according to FIG. 4 is that inside the propeller shaft 24₅ there are provided third coupling means 40 which, more particularly, are provided in the form of a friction coupling. When the second driving axle 8 is connected, the third coupling means 40 allow the torque to be transmitted to the second driving axle 8 to be controlled in accordance with requirements. According to a first possibility, the third coupling means 40 can be provided in the form of an active, respectively an externally controllable coupling, and the torque distributed to the secondary driving axle 8 can be set on demand as a function of the driving condition by a controllable axial setting device which acts on the coupling. Alternatively, the third coupling means 40 can also be provided in the form of a so-called passive, respectively uncontrolled coupling. Such a coupling which, for example, can be provided in the form of a viscous coupling closes automatically if there exists a speed differential between its input part and output part.

FIG. 6 shows an inventive drive assembly in a further embodiment which largely corresponds to that shown in FIG. 1, so that, as far as common features are concerned, reference can be made to the above description. Identical components have been given the same reference numbers, and the reference numbers of any components which are modified have been given the subscript 6.

The embodiment according to FIG. 6 is modified as compared to FIG. 1 in that the second coupling means 26₆ of the present drive assembly 2 comprise a friction coupling 51 and a form-fitting clutch 52 which are functionally connected in series. The form-fitting clutch 52 is arranged in the torque flow between the friction coupling 51 and the second differential drive 27 and serves to release the complete friction coupling 51. The coupling input part 53 of the clutch 52 is connected to the output part 43 of the friction coupling 51 and the coupling output part 54 of the clutch 52 is connected to the differential carrier 44 of the differential drive 27. The present embodiment is advantageous in that, when the clutch 52 is open, the drag moments in the friction coupling 51 can be reduced further. The output part 43 of the friction coupling 52, which preferably is provided in the form of an inner plate carrier, is disconnected from the rotating differential carrier 44 when the clutch 52 is open, and stands still.

For connecting the second driving axle 8, first the rear clutch 52 is closed, so that the output part 43 of the friction coupling 51 is coupled to the differential carrier 44 and rotates jointly therewith. Then the friction coupling 51 is started by actuating the axial setting device (not shown) in such a way that the input part 18 and the output part 19 of the front clutch 22 are at least partially synchronised. In this condition, it is possible to close the front clutch 22 in a low-noise way so that the second driveline 7 is coupled to the first driveline 5. By actuating, if required, the friction coupling 51, the torque to be transmitted to the second driving axle 8 can now be set.

FIG. 7 shows an inventive drive assembly in a further embodiment which largely corresponds to that shown in FIG. 3, so that, as far as common features are concerned, reference can be made to the above description. Identical components have been given the same reference numbers, and the reference numbers of any components which are modified have been given the subscript 7.

In the embodiment which is modified as compared to FIG. 3, the first coupling means 22₇ comprise a form-fitting clutch 55 and a synchronising unit 56. As in the case of the embodiment according to FIG. 3, the form-fitting clutch 55 comprises a coupling input part 18₇ which is drivingly connected to the transfer case 12, as well as a coupling output part 19₇ which is drivingly connected to the propeller shaft 24 via the angle drive 23. The synchronising unit 56 which, functionally, is preferably arranged parallel to the form-fitting clutch 55 ensures that the speeds of the two coupling parts 18₇, 18₇ are at least partially adapted to one another prior to these being closed. For this purpose, the synchronising unit 56 comprises paired friction faces which preferably comprise conical friction faces, as well as spring means 57.

When the first coupling means 22₇ are actuated by the actuator (not shown), first the two friction faces are axially resiliently loaded relative to one another, so that the two coupling parts 18, 19 of the clutch 55 are at least partially synchronised in respect of their speeds. In this way switching noises are avoided when subsequently closing the form-fitting clutch 55. In the closed condition of the clutch 55, the second driveline 7 is coupled to the first driveline 5. By actuating the second coupling means 26₇ as required which, in the present embodiment, are provided in the form of a friction plate coupling, it is now possible to set the torque to be transmitted to the second driving axle 8.

FIG. 8 shows an inventive drive assembly in a further embodiment. The present embodiment in respect of design of the first coupling means 22 corresponds to the embodiment according to FIG. 7, to the description of which reference is hereby made. Apart from that, the present embodiment of the drive assembly corresponds to the drive assembly according to FIG. 4, to the description of which reference is also made. Identical components have been given the same reference numbers and the reference numbers of modified components have been given the subject 8.

The special feature of the present drive assembly refers to a combination of the first coupling means 22₈ comprising a form-fitting clutch 55 and a synchronising unit 56, with the second coupling means 26₈ which are provided in the form of a form-fitting clutch. By ensuring at least partially a constant velocity between the coupling parts 18, 19 of the form-fitting clutch 55 prior to the switching process being carried out by the synchronising unit 56, it is possible to switch at low driving speeds.

FIG. 9 shows an inventive drive assembly in a further embodiment which, in many respects, corresponds to that shown in FIG. 1. As far as the common features are concerned, reference is made to the above description, with identical components having been given the same reference numbers and with the reference numbers of modified parts having been given the subscript 9.

The present drive assembly 2 is characterised in that the rear axle is the permanently driven first driving axle 6₉ and that the front axle is the second driving axle 8₉ which can be connected when required. It can be seen that the driving unit 4₉ is built in longitudinally, in contrast to the above embodiments according to FIGS. 1 to 8 in which the drive unit is built in transversely. The drive unit 4 is followed by a transfer case 12₉ which comprises a direct drive 61 via which the first driving axle 6₉ is driven permanently. Furthermore, the transfer case 12₉ comprises first coupling means 22₉ for on demand connecting the second driveline 5₉. The first coupling means 22₉ are preferably provided in the form of a friction plate coupling whose inner plates 63 are connected to the direct drive 61 in a rotationally fixed way, and whose outer plates 64, via a gearing 65, drive the propeller shaft 24₉. For supporting the direct drive 61, respectively the inner plate carrier of the first coupling means 22₉, there are provided first bearing means 36₉, 36₉′. For rotatably supporting the outer plate carrier of the first coupling means 22₉, respectively the gear 60 connected thereto, there are provided second bearing means 59, 59′. In the present embodiment, the transfer case 12₉ comprises coupling means 22₉ in the form of the friction plate coupling. Instead of the friction plate coupling, it would also be possible to use a central differential for equalising the rotational speed between the rear axle and the front axle.

The second longitudinal driveshaft 24₉ serves to transmit torque from the transfer case 12₉ to the second driving axle 8₉ via the second angle drive 25₉ . The assembly consisting of the second coupling means 26₉ and the second differential drive 27₉ is functionally designed like the corresponding rear axle unit according to FIG. 1 to the description of which reference is hereby made. It can be seen that the coupling housing 62 to which the coupling input part 42₉ is connected in a rotationally fixed way is rotationally supported by bearing means 67, 67′around the axis of rotation A. The differential carrier 17₉ is rotatably supported in the coupling housing 62 by further bearing means 68, 68′.

In the case of the present drive assembly 2, the first driveline 5 comprises the first propeller shaft 66, and the first angle drive 23 and the first differential drive 58 which serves to drive the rear first driving axle 6. The connectable second driveline 7 comprises the first coupling means 22₉, the gearing 65, the second propeller shaft 24₉ and the second differential drive 27₉ which serves to drive the front second driving axle 8₉.

The special feature of the present embodiment consists in that, by means of the first coupling means 22₉ and the second coupling means 26, the gearing 65, the second propeller shaft 24₉ and the front second angle drive 25 including the coupling input part 42 can be disconnected when the first and the second coupling means 22₉, 26₉ are open. In this deactivated condition, said assemblies and components are stationary, more particularly also the bearing in which the rotating parts are rotatably supported, so that power losses due to drag moments and friction are reduced. This in turn results in a reduction in fuel consumption for those vehicle conditions in which only the rear first driving axle 6₉ is driven and in which the front second driving axle 8₉ runs in a torque-free condition.

All the above-described drive assemblies are advantageous in that, when the coupling means 22 and 26 are open, the second driveline 7 is substantially stationary, i.e. the first angle drive 23, the associated propeller shaft 24 and the second angle drive 25 no longer rotate. More particularly, in the disconnected condition, also the bearing means 33, 33′, 36, 36′, 37, 37′, 49, 49′ in which said components are rotatingly supported, stand still. In this way, unwanted drag moment and friction losses are minimised, which has an advantageous effect on the fuel consumption of the motor vehicle.

### LIST OF REFERENCE NUMBERS

2 drive assembly

3 motor vehicle

4 drive unit

5 first driveline

6 first driving axle

7 second drive line

8 second driving axle

9 coupling

10 switching gear

11 internal combustion engine

12 first differential drive

13 sideshaft

14 sideshaft

15 wheel

16 wheel

17 differential carrier

18 input part

19 output part

22 first coupling means

23 first angle drive

24 propeller shaft

25 second angle drive

26 second coupling means

27 second differential drive

28 input shaft

29 ring gear

30 bevel gear

33 bearing means

34 first shaft portion

35 second shaft portion

36 bearing means

37 bearing means

38 bevel gear

39 ring gear

40 third coupling means

41

42 input part

43 output part

44 differential carrier

45 sideshaft

46 sideshaft

47 wheel

48 wheel

49 bearing means

50

51 friction coupling

52 switching coupling

53 input part

54 output part

55 switching coupling

56 synchronising unit

57 spring means

58 differential drive

59 bearing means

60 gearwheel

61 direct drive

62 coupling housing

63 inner plates

64 outer plates

65 wheel drive

66 propeller shaft

67 bearing means

68 bearing means

A axis of rotation

B axis of rotation

C axis of rotation

1. A drive assembly for a motor vehicle with a drive unit and multiple driven axles, the drive assembly comprising
a transfer case (12) which distributes torque introduced by the drive unit (4) to a first driveline (5) and to a second driveline (7), wherein the first driveline (5) is permanently drivingly connected to the transfer case (12) in order to transmit torque to a first driving axle (6), and wherein optionally, in addition to the first driveline (5), the second driveline (7) can be drivingly connected to the transfer case (12) in order to transmit torque to the second driving axle (8), and
a propeller shaft (24) which is arranged in the torque flow between the transfer case (12) and the second driving axle (8),
characterised
by first coupling means (22) for coupling and uncoupling the propeller shaft (24) relative to the drive unit (4), as well as
by second coupling means (26) for coupling and uncoupling the propeller shaft (24) relative to the second driving axle (8).

2. A drive assembly according to claim 1,
characterised in
that the second driveline (7) comprises a first angle drive (23) which is arranged in the torque flow between the drive unit (4) and the propeller shaft (24).

3. A driveline according to claim 2,
characterised in
that the first coupling means (22) are arranged in the torque flow between the drive unit (4) and the first angle drive (23).

4. A drive assembly according to any one of claims 1 to 3,
characterised in
that the first coupling means (22) are arranged coaxially to or in parallel with the first driving axle (6).

5. A drive assembly according to any one of claims 1 to 4,
characterised in
that the transfer case (12) comprises a first differential drive (58) with a differential carrier (17), wherein the differential carrier (17) is drivingly connected to the drive unit (4).

6. A drive assembly according to claim 5,
characterised in
that the first coupling means (22) comprise an input part (18) and an output part (19), wherein the input part (18) is drivingly connected to the differential carrier (17) of the first differential drive (12) and wherein the output part (19) is drivingly connected to an input shaft (28) of the first angle drive (23).

7. A drive assembly according to any one of claims 1 to 6,
characterised in
that the second driveline (7) comprises a second angle drive (25) for transmitting torque from the propeller shaft (24) to the second driving axle (8).

8. A drive assembly according to claim 7,
characterised in
that the second driving axle (8) comprises a second differential drive (27), wherein the second coupling means (26) are arranged in the torque flow between the second angle drive (25) and the second differential drive (27).

9. A drive assembly according to claim 8,
characterised in
that the second coupling means (26) comprise an input part (42) and an output part (43), wherein the input part (42) is connected in a rotationally fixed way to a ring gear (39) of the second angle drive (25) and wherein the output part (43) is connected in a rotationally fixed way to a differential carrier (44) of the second differential drive (27).

10. A drive assembly according to any one of claims 1 to 9,
characterised in
that at least one of the coupling means (22, 26) comprises a clutch. (FIGS. 1, 2).

11. A drive assembly according to any one of claims 1 to 10,
characterised in
that at least one of the coupling means (22, 26) comprises a friction coupling (1, 2). (FIGS. 1, 2)

12. A drive assembly according to any one of claims 1 to 9,
characterised in
that the first and the second coupling means (22, 26) comprise a friction coupling. (FIG. 3).

13. A drive assembly according to any one of claims 1 to 9,
characterised in
that the first and the second coupling means (22, 26) comprise a clutch. (FIGS. 4, 5)

14. A drive assembly according to any one of claims 1 to 13,
characterised in
that the propeller shaft (24) comprises several parts.

15. A drive assembly according to claim 14,
characterised in
that the propeller shaft (24) comprises a first shaft portion (34) and a second shaft portion (35), wherein there are arranged third coupling means (40) between the first and the second shaft portion (34, 35).

16. A drive assembly according to any one of claims 1 to 15,
characterised in
that the second coupling means (26) comprise a friction coupling (51) and a form-fitting clutch (52). (FIG. 6).

17. A drive assembly according to any one of claims 1 to 15,
characterised in
that the first coupling means (22) comprises a form-fitting clutch (55) and a synchronising unit (56). (FIGS. 7, 8).

18. A drive assembly according to any one of claims 1 to 4,
characterised in
that the transfer case (12) comprises a direct drive (61) which permanently drives the first driving axle (6) via a first propeller shaft (66), and that the transfer case further comprises the first coupling means (22) for optionally connecting the second driveline (7), wherein the second driveline (7) comprises a second propeller shaft (24) for optionally driving the second driving axle (8). (FIG. 9)

19. A drive assembly according to claim 18,
characterised in
that the permanently driven first driving axle (6) constitutes the rear axle and that the optionally driveable second driving axle (8) constitutes the front axle of the motor vehicle.

20. A drive assembly according to any one of claim 18 or 19,
characterised in
that the second coupling means (26) comprise a friction coupling or a form-fitting clutch.
